(19) United States
(12) Patent Application Publication
(10) Pub. No.: US 2006/0282586 A1
(43) Pub. Date: Dec. 14, 2006

(54) Bus system design method and apparatus

(75) Inventor: Hiroshi Shibuya, Kanagawa (JP)

Correspondence Address: FOLEY AND LARDNER LLP;SUITE 500, 3000 K STREET NW, WASHINGTON, DC, 20007, US

(73) Assignee: NEC Electronics Corporation

(21) Appl. No.: 11/448,050

(22) Filed: Jun. 7, 2006

(30) Foreign Application Priority Data
Jun. 8, 2005 (JP) 2005-168276

(51) Int. Cl. G06F 13/00

(52) U.S. Cl. 710/110

(57) ABSTRACT

Disclosed is an apparatus for designing a bus system including a bus master that generates a Transfer-Layer bus transaction, a bus master that generates a Transaction-Layer bus transaction, and a bus via which a bus transaction is transferred from a bus master to a bus slave, in which the base model of a slave having the Transfer-Layer bus interface includes a transaction layer transaction receive function for receiving a Transaction-Layer bus transaction, receives a transferred Transaction-Layer bus transaction, converts transfer information to transfer information corresponding to a Transfer-Layer bus transaction, and calls a function corresponding to the Transfer-Layer transaction. The base model of a slave having the Transaction-Layer bus interface includes a transfer layer transaction receive function for receiving a Transfer-Layer bus transaction, receives a transferred Transfer-Layer bus transaction, converts transfer information to transfer information corresponding to a Transaction-Layer bus transaction, and calls a function corresponding to the Transaction-Layer transaction.

### FIELD OF THE INVENTION

The present invention relates to a system design environment, and more particularly to an apparatus, a method, and a computer program for simulation that can be advantageously applied to the verification and performance evaluation of a bus system.

### BACKGROUND OF THE INVENTION

With the shrinking of transistor dimensions and increased integration density in a semiconductor integrated circuit, it has become more and more difficult to conduct architecture verification at the RTL (Register Transfer Level) in the SoC (System on Chip) design process. Especially, it is difficult to verify the performance of a processor at the RTL if the processor executes application codes. One of the methods for increasing the speed of architecture verification is the abstraction of a simulation model. This is implemented by performing modeling at an abstraction function level which is higher than that of the RTL and by conducting simulation at the abstraction function level to increase the simulation speed for attaining faster verification. In the design and verification of the architecture of a system including a bus (for example, performance evaluation and analysis of a bus), a cycle-accurate transaction level model (Transaction Level Modeling: TLM) is used. A processor, a bus, an I/O device, and a memory each are provided by the library as transaction level models. In transaction level modeling, the bus protocol is modeled in the bus model with each IP communicating with the bus model via API (Application Programming Interface). A TLM bus model has bus-cycle accuracy that makes the simulation several times faster than RTL level simulation.

In case where a model at a level higher than the RTL level is abstracted, the abstraction level of the model is not unique. There are multiple abstraction levels for simulation models, and each model and the bus interface of the model are modeled at a desired verification level. In this case, a bus model must be prepared according to the abstraction level of a bus transaction. For example, a cycle-accurate bus and a cycle countable bus both are prepared. This is because a bus model supports a protocol at a single abstraction level. If a peripheral model, designed for a bus transaction with an abstraction level different from that of the bus transaction supported by the bus, is going to be connected to the bus, an abstraction level conversion adapter is inserted between the bus and the peripheral model. That is, an abstraction level conversion adapter is inserted between a bus master and the bus for converting the abstraction level of a transaction received from the bus master to the bus-provided transaction abstraction level. Similarly, an abstraction level conversion adapter is inserted between the bus and a bus slave for converting the abstraction level of a transaction sent from the bus to the transaction abstraction level supported by the bus slave (for example, see FIGS. 7A and FIG. 7B).

For a bus and a peripheral model modeled in object-oriented language, see Patent Document 1 and Patent Document 2. However, neither Patent Document 1 nor Patent Document 2 discloses a bus that processes bus transactions at different abstraction levels.

[Patent Document 1]

Japanese Patent Kokai Publication No. JP-P2003-15968A

[Patent Document 2]

Japanese Patent Kokai Publication No. JP-P2004-341737A

### SUMMARY OF THE DISCLOSURE

It is a pending problem in the verification of the bus system operation how to connect bus interfaces at different abstraction levels for the operation. The problem may be solved by preparing a model of a bus peripheral device, which configures the bus system to be verified, for each of the different abstraction levels. However, this method is not practical.

In order to allow the devices communicating via the bus and having bus interfaces at different abstraction levels to issue bus transactions at different abstraction levels as described above, a bus model must be prepared for each bus transaction abstract level.

In case wherein a bus peripheral model designed for a bus transaction at an abstraction level different from the bus-provided transaction abstraction level is connected to the bus, an abstraction level conversion adapter must be inserted between the bus and the peripheral model, as a result of which the processing overhead is increased.

In case wherein the abstraction levels of bus transactions of both a bus master and a bus slave are the same but different from the abstraction level of a transaction supported by the bus model, an abstraction level conversion adapter must be provided on both the bus master and the bus slave. This configuration increases the overhead. For example, for enabling the communication between a bus master and a bus slave that are both cycle-accurate, via a bus that is a cycle-countable-accurate model, it is necessary to provide abstraction conversion adapters both on the master and the slave.

According to one aspect of the present invention, there is provided an apparatus for designing and verifying a bus system by which a bus transaction from a bus master is transferred to a bus slave via a bus, wherein a bus slave, which has a bus interface corresponding to one of at least two different abstraction levels of a simulation model and receives a bus transaction at the one level, comprises a transaction receive unit whereby the bus slave receives a bus transaction corresponding to another level and, when the bus transaction at the another level is transferred from the bus master to the bus slave, the transaction receive unit of the bus slave receives the transferred bus transaction at the another level, converts a part of information on the bus transaction to information corresponding to a transaction at the one level, and executes processing corresponding to a bus transaction at the one level.

According to another aspect of the present invention, there is provided a method comprising the steps of:

issuing, by a bus master, a bus transaction at least at one of at least two different abstraction levels of a simulation model to the bus; and

transferring, by the bus, the bus transaction from the bus master to a bus slave,

wherein, in a bus slave having a bus interface corresponding to one of the two levels, a transaction receive function for receiving a bus transaction at another level is provided in advance, and wherein

when a bus transaction at the another level is transferred from the bus master to the bus slave via the bus, the method further comprising the step, by the transaction receive function for receiving the transaction at the another level, of receiving the bus transaction at the another level, converting the received bus transaction to a transaction at the one level, and calling a function corresponding to a bus transaction at the one level.

According to still another aspect of the present invention, there is provided a computer program (for example, a computer program stored in a computer readable storage medium) causing a computer, which configures design device for a system including a bus, to perform:

processing in which a bus master issues a bus transaction at least at one of at least two different abstraction levels of a simulation model to the bus; and

processing in which the bus transfers the bus transaction from the bus master to a bus slave,

wherein, in a bus slave having a bus interface corresponding to one of the two levels, a transaction receive function for receiving a bus transaction at another level is provided in advance, and

when a bus transaction at the another level is transferred from the bus master to the bus slave via the bus, the program further causing the computer to perform processing in which the transaction receive function for receiving the transaction at the another level receives the bus transaction at the another level, converts the received bus transaction to a transaction at the one level, and calls a function corresponding to a bus transaction at the one level.

According to the present invention, in the bus slave, a base model of the one level has a function for receiving the bus transaction at the another level and a function for receiving the bus transaction at the one level is declared as a pure virtual function.

According to the present invention, when processing corresponding to the bus transaction at the one level is executed, a bus transaction function at the one level, which inherits the base class, is called.

The meritorious effects of the present invention are summarized as follows.

The present invention eliminates the need for preparing a bus model for each bus transaction abstraction level.

When a peripheral model (bus master, bus slave) for sending and receiving a bus transaction at an abstraction level different from that of a transaction provided by the bus is connected to the bus, the present invention eliminates the need for inserting an abstraction level conversion adapter between the bus and the peripheral model, thereby reducing the processing overhead.

Still other features and advantages of the present invention will become readily apparent to those skilled in this art from the following detailed description in conjunction with the accompanying drawings wherein only the preferred embodiments of the invention are shown and described, simply by way of illustration of the best mode contemplated of carrying out this invention. As will be realized, the invention is capable of other and different embodiments, and its several details are capable of modifications in various obvious respects, all without departing from the invention. Accordingly, the drawing and description are to be regarded as illustrative in nature, and not as restrictive.

### BRIEF DESCRIPTION OF THE DRAWINGS

FIG. 1 is a diagram showing the configuration of one preferred embodiment of the present invention.

FIG. 2 is a diagram showing bus transaction abstraction levels.

FIG. 3 is a diagram showing the operation of a Transfer-Layer slave base model.

FIG. 4 shows an example of the coding (C++) of a Transfer-Layer slave base model .

FIG. 5 shows an example the coding (SystemC) of a Transfer-Layer slave base model.

FIG. 6 shows an example of the coding of a Transfer-Layer slave model (derived class).

FIGS. 7A and 7B are diagrams showing the overhead of a comparison example and FIG. 7C is a diagram showing the overhead incurred by the present invention.

FIG. 8 is a diagram showing the design process of a bus system in one embodiment of the present invention.

FIGS. 9A and 9B show examples of the definition of Transaction-Layer API and the Transfer-Layer API, respectively.

FIG. 10 is a diagram showing the configuration of a bus.

FIG. 11 shows an example of the coding (SystemC) of a Transaction-Layer slave base class.

FIG. 12 shows an example of the coding (SystemC) of a Transfer-Layer slave base class.

FIG. 13 shows an example of the coding (SystemC) of a Transaction-Layer slave class.

FIG. 14 shows an example of the coding (SystemC) of a Transfer-Layer slave class.

### PREFERRED EMBODIMENTS OF THE INVENTION

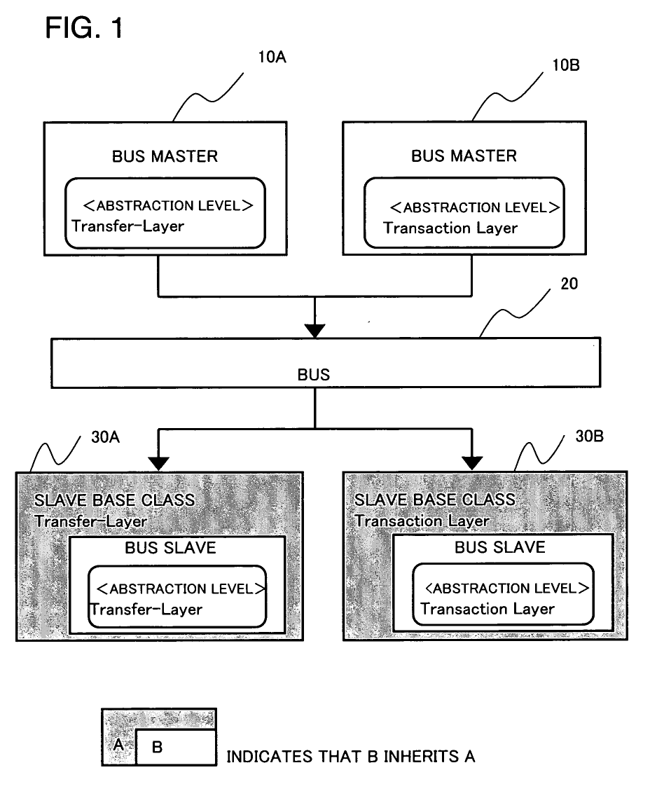

The present invention will be described more in detail below with reference to the attached drawings. Referring to FIG. 1, a bus system according to the present invention comprises a first bus master 10A and a second bus master 10B. The first bus master 10A generates a bus transaction at the Transfer-Level, whose abstraction level is higher than the RTL and at which the read/write address phase and the data phase are defined as one bus cycle. The first bus master 10A issues the generated bus transaction to a bus 20. The second bus master 10B generates a bus transaction at the Transaction-Level, whose abstraction level is higher than the Transfer-Level and at which a read/write is defined as one bus cycle. The second bus master 10B issues the generated bus transaction to the bus 20. The bus 20 decodes the bus transaction from the bus masters 10A and 10B and transfers the decoded transaction to a destination bus slave.

The base model (base class) of a bus slave 30A having the Transfer-Level bus interface includes a Transaction-Layer (transaction layer) transaction receive function for receiving a Transaction-Level bus transaction. When a Transaction-Level bus transaction is transferred to the bus slave 30A, the Transaction-Layer transaction receive function receives the transferred Transaction-Level bus transaction, obtains the address and data corresponding to the Transfer-Level bus transaction from the transferred object, and calls a function corresponding to the Transfer-Level transaction. When a Transfer-Level bus transaction is transferred to the bus slave 30A, the Transfer-Layer transaction receive function of the slave model that has inherited the base model is invoked.

The base model (base class) of a bus slave 30B having the Transaction-Level bus interface includes a Transfer-Layer (transfer layer) transaction receive function for receiving a Transfer-Level bus transaction. When a Transfer-Level bus transaction is transferred to the bus slave 30B, the Transfer-Layer transaction receive function receives the transferred Transfer-Level bus transaction, converts the received bus transaction to a transfer object corresponding to the Transaction-Level bus transaction using the address and data information, and calls a function corresponding to the Transaction-Level transaction. When a Transaction-Level bus transaction is transferred to the bus slave 30B, the Transaction-Layer transaction receive function of the slave model that has inherited the base model is invoked.

As described above, the present invention uses derivation (inheritance), supported by object-oriented language, to perform modeling of a slave model with on a model, which has the bus transaction abstraction level conversion function, as its base. That is, the present invention allows one bus model to process bus transactions at multiple different abstraction levels without using a bus transaction abstraction level conversion adapter.

To speed up the verification in the design process of large-scale integrated circuits such as an SoC as described above, a bus master and a bus slave are modeled at an abstraction level higher than the RTL using object-oriented language. Because a bus master, a bus slave, and a bus peripheral model are modeled individually, the abstractions levels of respective bus transactions are not always equal.

The following describes the abstraction level of bus transactions (OCP-IP: OCP International Partnership Association Inc.). There are the following model abstraction levels: RTL, Transfer-Layer, Transaction-Layer, and Message-Layer.

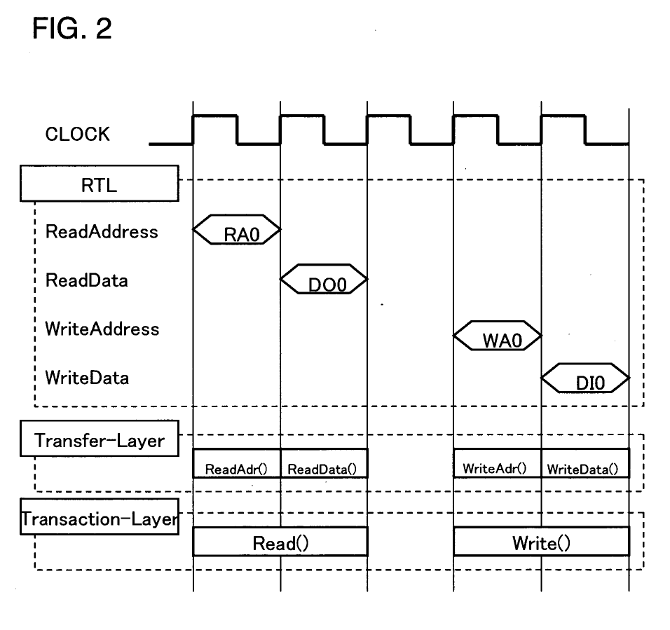

FIG. 2 shows an example of bus transaction abstraction levels for the RTL, Transfer-Layer, and Transaction-Layer.

RTL in FIG. 2 represents an example of the RTL abstraction level.

Although the bus interface pins are abstracted and hidden in the Transfer-Layer shown in FIG. 2, the accuracy of the Transfer-Layer is the same as that of the RTL when a bus transaction is evaluated on a cycle basis.

The Transaction-Layer shown in FIG. 2 has an abstraction level higher than that of the Transfer-Layer. Although a bus transaction of the Transaction-Layer is not necessarily equal to that of the RTL when evaluated on a cycle basis, the timing sequence from the start to the end of a transaction is equivalent to that of the RTL.

The Message-Layer has an abstraction level higher than that of the Transaction-Layer. In the Message-Layer, communication is carried out without considering the timing sequence, data is directly transferred between the sending side and the receiving side, and the bus is not necessarily required. Since the Message-Layer is not dealt with in this specification, its description is omitted.

The present invention provides a bus system that allows a bus master and a bus slave, either at the Transfer-Layer or Transaction-Layer, to connect to the bus without using an adapter.

The communication between a Transfer-Layer or Transaction-Layer bus master and bus slave, modeled in object-oriented language, is accomplished by calling a function prepared for communication. When a bus master reads data from a slave, the Transfer-Layer bus master calls the address phase function ReadAdr( ) and the data phase function ReadData( ). The Transaction-Layer bus master calls only the function Read( ). When a bus master writes data to a slave, the Transfer-Layer bus master calls the address phase function WriteAdr( ) and the data phase function WriteData( ). The Transaction-Layer bus master calls the function Write( ).

A bus master issues a transaction to the bus regardless of the abstraction level of the bus interface of a bus slave, to which the bus transaction is to be sent. A bus master, which has the Transfer-Layer bus interface or the Transaction-Layer bus interface, issues a Transfer-Layer bus transaction or a Transaction-Layer bus transaction, respectively.

Whether the transaction is a Transfer-Layer transaction or a Transaction-Layer transaction, the bus transfers the transaction to the destination bus slave.

In the preferred embodiment, a bus slave has a base model according to the bus transaction abstraction level required by the slave model.

That is, when a bus slave has the Transfer-Layer bus interface, the bus slave has a Transfer-Layer base model (base class) and, when the bus slave has the Transaction-Layer bus interface, the bus slave has a Transaction-Layer base model (base class). The slave model inherits this base model.

The base model (base class) of a slave converts the abstraction level. When a Transaction-Layer bus transaction is transferred from a bus master to a slave having the Transfer-Layer bus interface, the base model of the slave converts the Transaction-Layer bus transaction to a Transfer-Layer bus transaction. When a Transfer-Layer bus transaction is transferred from the bus master to a slave having the Transfer-Layer bus interface, the base model of the slave does not convert the transaction.

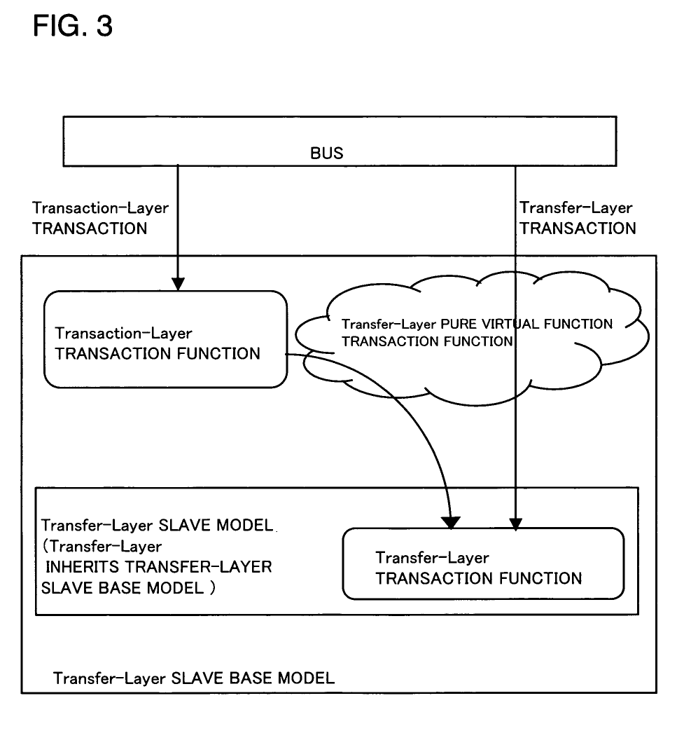

FIG. 3 is a diagram schematically showing a Transfer-Layer bus slave base model (base class). The Transfer-Layer bus slave base model has the function installed for receiving a Transaction-Layer transaction and declares the function for receiving a Transfer-Layer transaction as a pure virtual function.

The Transfer-Layer bus slave base model (base class) has the Transaction-Layer transaction receive function. The Transaction-Layer transaction receive function converts a transaction to a Transfer-Layer transaction. At an appropriate time, this function calls the Transfer-Layer transaction receive function defined as a pure virtual function. A call to the Transfer-Layer transaction function, which is a pure virtual function, is a call to the Transfer-Layer transaction receive function in the slave model that inherits the slave base model.

In the present embodiment, the Transfer-Layer transaction reception write function is defined as follows:

response_type WriteAddress(address_type address);

response_type WriteData(data_type data);

The Transaction-Layer transaction reception write function is defined as follows:

response_type Write(transaction_type *trans);

The class name of the Transfer-Layer bus slave base model (base class) is slave_base_ctlm. The class name of the slave model is slave_module_ctlm.

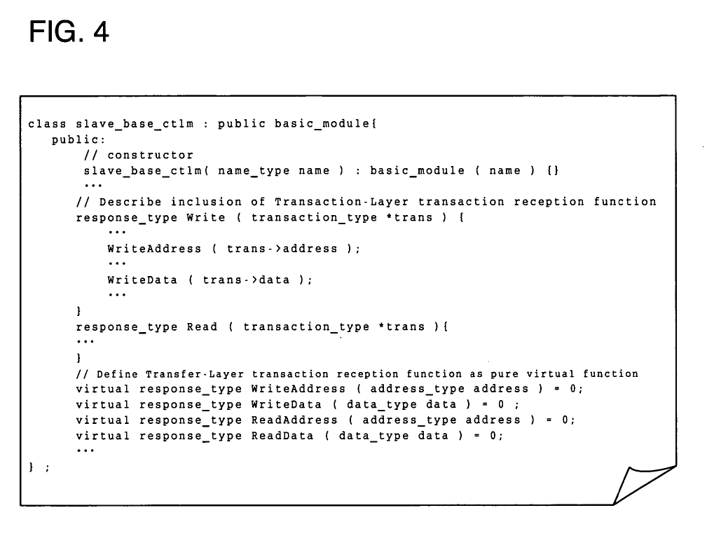

FIG. 4 is a diagram showing an example of the Transfer-Layer bus slave base model coded in C⁺⁺. In this Transfer-Layer bus slave base model, the Transfer-Layer transaction receive function is defined as a pure virtual function (This is provided for use as the base class of another class. No object is generated in this class, that is, the member function definition is omitted and no instance can be generated). A constructor, defined as a member function with the same name as the class name (“slave_base_ctlm” in FIG. 4), is called automatically when an instance is generated. “virtual” in “virtual response_type WriteAddress(address_type address)=0;” defines that the function is a virtual function, and “=0” defines that the function is a pure virtual function. In the Transaction-Layer, the bus transfer address and the transfer data are encapsulated to carry out communication using higher-abstraction-level transfer objects. “transaction_type” represents the type of the transaction.

As shown in FIG. 4, the Transaction-Layer transfer receive function Write obtains the address information (trans->Address) and the data information (trans->data) from the abstracted transfer object *trans.

After converting the abstraction level of the transfer information, the Transfer-Layer transfer receive functions WriteAddress and WriteData are called.

In the example shown in FIG. 4, though the Transfer-Layer transfer receive functions WriteAddress and WriteData are sequentially called in the Write function that is the Transaction-Layer transfer receive function, the present invention is not limited only to this configuration. As in Write, the Transaction-Layer transfer receive function Read also obtains the address information (trans->Address) and the data information (trans->data) from the abstracted transfer object *trans, and the Transfer-Layer transfer receive functions ReadAddress and ReadData are called.

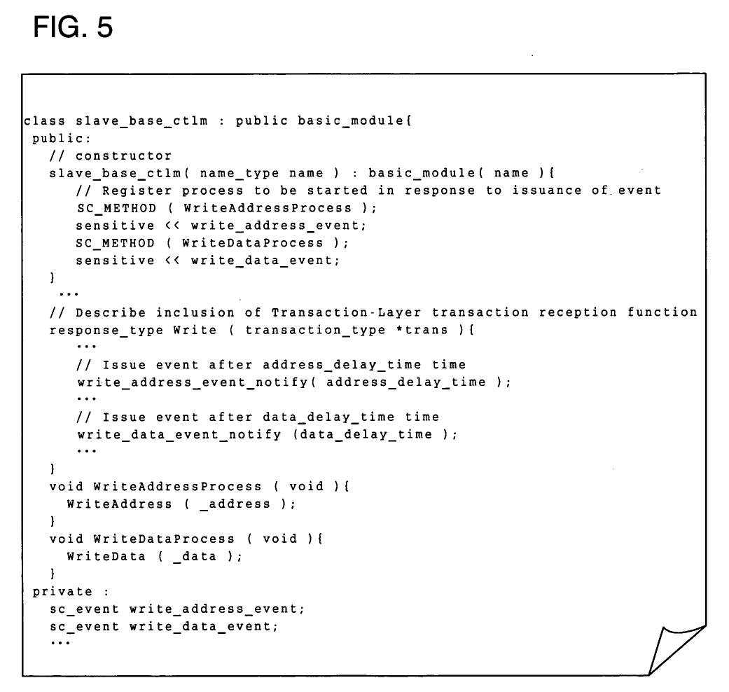

FIG. 5 is a diagram showing an example in which the base model is modeled in SystemC. Referring to FIG. 5, processes WriteAddressProcess and WriteDataProcess are provided that are invoked in response to the issuance (notify) of an event such as write_address_event and write_data_event declared as sc_event. The Transaction-Layer function Write adjusts the time at which an event is issued to determine the time at which the Transfer-Layer function is to be called. When to issue an event can be specified as an argument of the event issuing function ‘notify’. When an event is issued at an appropriate time, WriteAddressProcess and WriteDataProcess are invoked in response to the event, and (SC_METHOD(WriteAddressProcess); sensitive<<write_address_event; SC_METHOD(WriteDataProcess); sensitive<<write_data_event) and Transfer-Layer functions WriteAddress and WriteData are called.

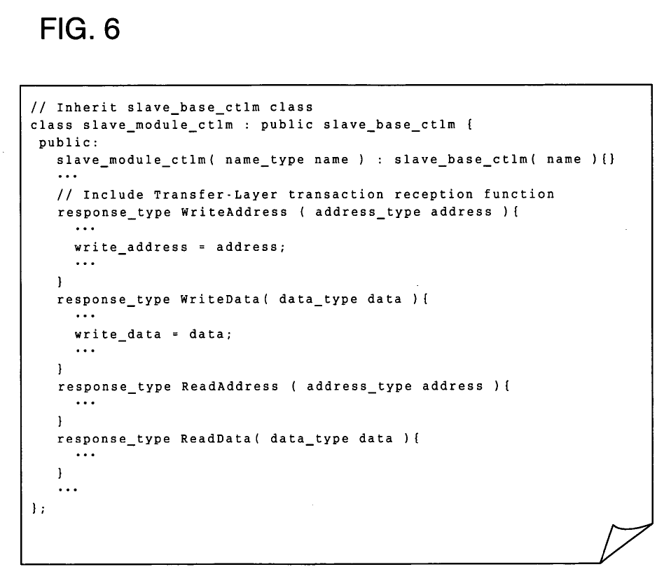

FIG. 6 is a diagram showing a slave model (derived class) that inherits the base model (base class). When a Transaction-Layer bus transaction is received, the Transfer-Layer transaction receive function of the bus slave model in the derived class is called from the Transaction-Layer transaction receive function implemented in the base model (base class) of the slave. When a Transfer-Layer bus transaction is received, the slave base model performs no operation and calls the Transfer-Layer transaction receive function of the slave model because the Transfer-Layer transaction receive function is defined as a pure virtual function in the slave base model.

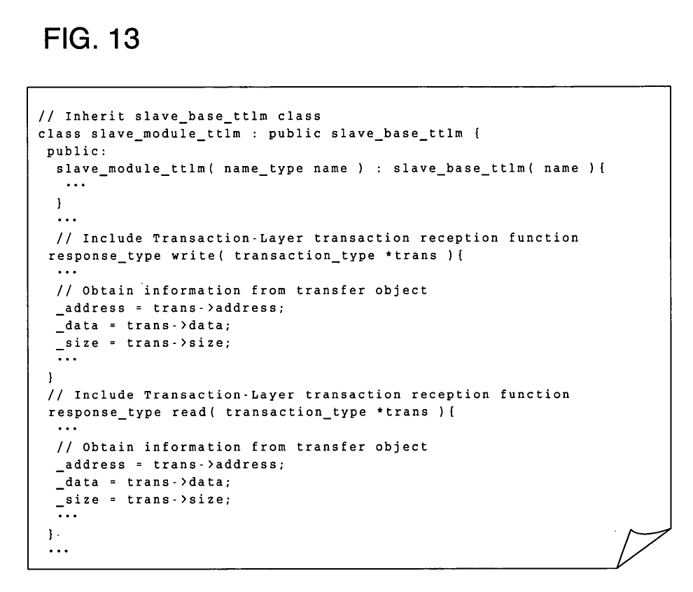

In the base model of the Transaction-Layer bus slave, a Transaction-Layer transaction and a Transfer-Layer transaction can be processed in the same way (see FIG. 13).

In the present embodiment, the bus does not depends on the abstraction level and the base class of a bus slave is designed in such a way that even if a bus master and a bus slave have different abstraction level interfaces, they are connected to the bus without an abstraction level conversion adapter for converting the abstraction level.

As compared with a case in which an abstraction level conversion adapter is connected, the present embodiment reduces the processing overhead of a bus master and a bus slave having the interfaces at different abstraction levels and speeds up the simulation.

In the description below, let X be the overhead of abstraction level conversion from the Transfer-Layer to the Transaction-Layer and the overhead of abstraction level conversion from the Transaction-Layer to the Transfer-Layer.

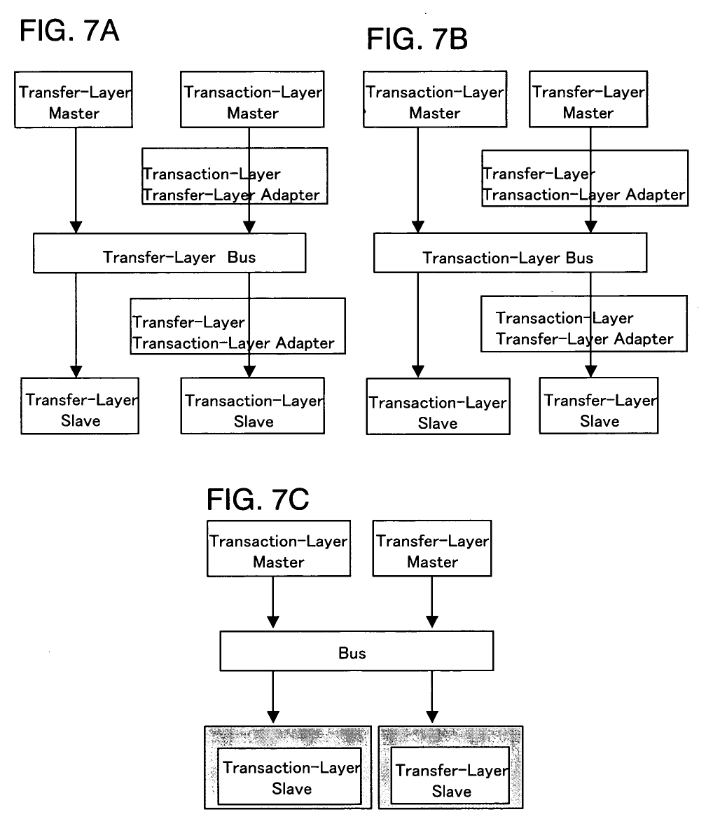

Referring to FIG. 7A, the system has a Transfer-Layer bus. A bus transaction from the bus master having the Transaction-Layer bus interface (indicated by Transaction-Layer Master) has its abstraction level converted by the Transaction-Layer->Transfer-Layer adapter from the Transaction-Layer to the Transfer-Layer. A transaction from the Transfer-Layer bus has its abstraction level converted by the Transfer-Layer->Transaction-Layer adapter to the Transaction-Layer before being transferred to the bus slave having the Transaction-Layer bus interface (indicated by Transaction-Layer Slave). The transfer overheads between the Transfer-Layer Master, the Transaction-Layer Master, the Transfer-Layer Slave, and the Transaction-Layer Slave are as follows.

Transfer-Layer Master=>Transfer-Layer Slave+0

Transfer-Layer Master=>Transaction-Layer Slave+X

Transaction-Layer Master=>Transfer-Layer Slave+X

Transaction-Layer Master=>Transaction-Layer Slave+2X

The simple sum of the overheads is +4X.

Referring to FIG. 7B, the system has a Transaction-Layer bus. A bus transaction from the bus master having the Transfer-Layer bus interface (indicated by Transfer-Layer Master) has its abstraction level converted by the Transfer-Layer->Transaction-Layer adapter from the Transfer-Layer to the Transaction-Layer. A transaction from the Transaction-Layer bus has its abstraction level converted by the Transaction-Layer->Transfer-Layer adapter to the Transfer-Layer before being transferred to the bus slave having the Transfer-Layer bus interface (indicated by Transfer-Layer Slave). The transfer overheads between the Transfer-Layer Master, the Transaction-Layer Master, the Transfer-Layer Slave, and the Transaction-Layer Slave are as follows.

Transfer-Layer Master=>Transfer-Layer Slave+2X

Transfer-Layer Master=>Transaction-Layer Slave+X

Transaction-Layer Master=>Transfer-Layer Slave+X

Transaction-Layer Master=>Transaction-Layer Slave+0

The simple sum of the overheads is +4X.

As shown in FIG. 7C, the overheads in the system according to the present invention are as follows.

Transfer-Layer Master=>Transfer-Layer Slave+0

Transfer-Layer Master=>Transaction-Layer Slave+X

Transaction-Layer Master=>Transfer-Layer Slave+X

Transaction-Layer Master=>Transaction-Layer Slave+0

The simple sum of the overheads is +2X. Thus, the overhead is reduced according to the present invention.

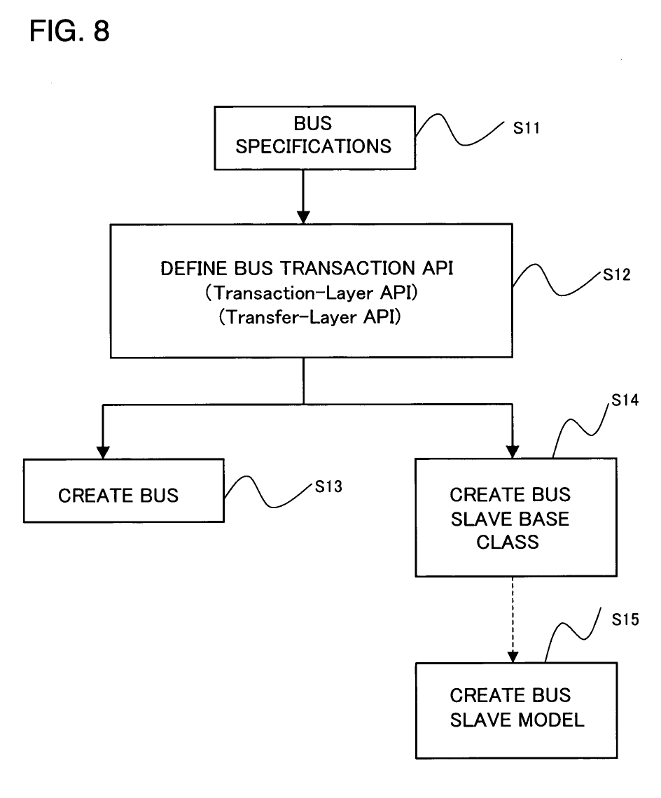

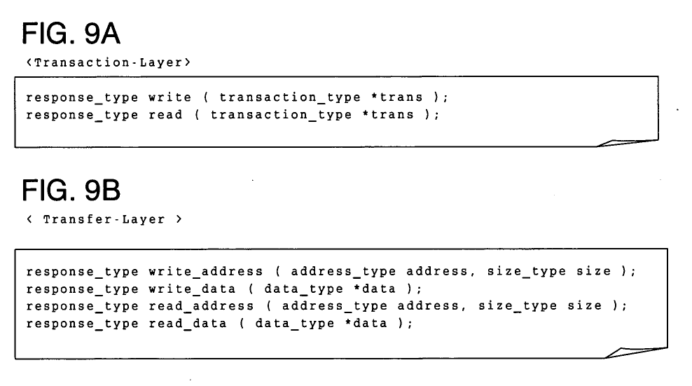

FIG. 8 is a diagram showing a design method in accordance with an embodiment of the present invention. In step S12, the bus transaction API (Application Programming Interface) is defined from the bus specifications. FIG. 9A and FIG. 9B show the Transaction-Layer API (write and read) and the Transfer-Layer API (write_address and write_data, and read_address and read_data).

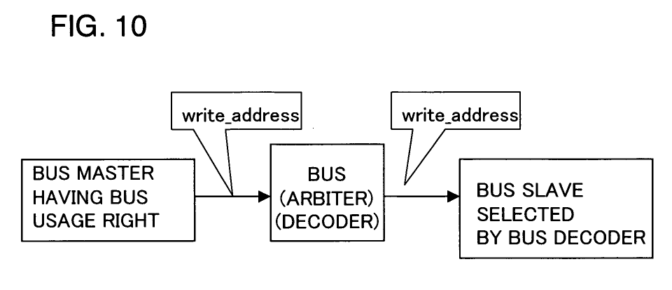

In step S13, the functions specific to the bus, such as arbiter, decoder, etc., are implemented based on the bus specifications. As shown in FIG. 10, communication is carried out from a bus master having the bus access right to a bus slave (slave selected by the bus decoder) using the bus transaction API.

In step S14, the base class of the bus slave is created.

In the Transaction-Layer slave base model, the Transaction-Layer API is declared as a pure virtual function. The Transfer-Layer API is implemented so as to call the Transaction-Layer API.

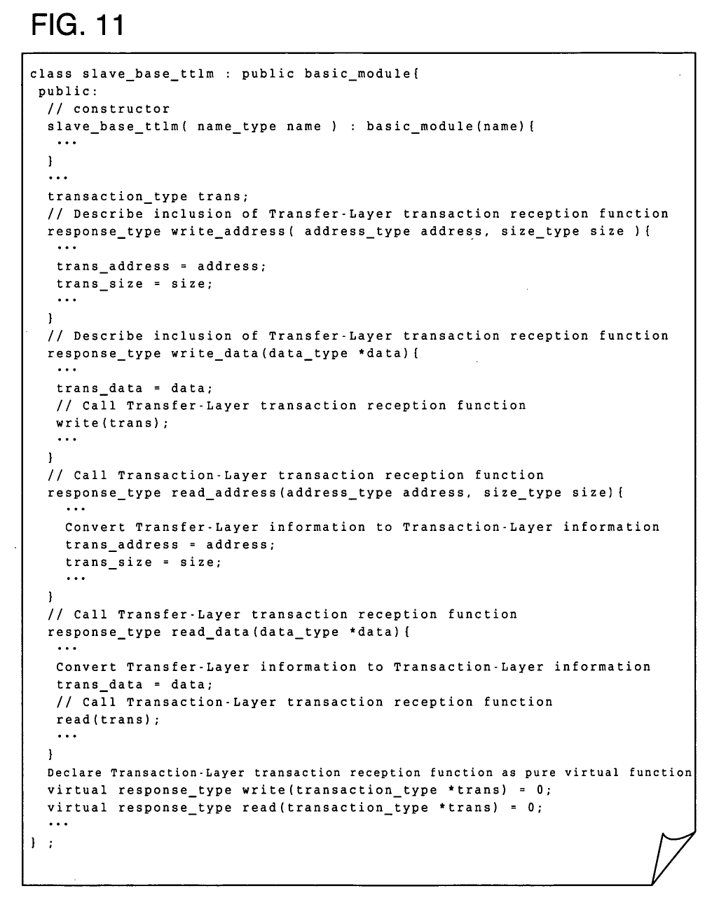

FIG. 11 is a diagram showing an example of the Transaction-Layer slave base model coded in SystemC as one embodiment of the present invention. As shown in FIG. 11, the Transfer-Layer transaction receive function is implemented in the Transaction-Layer slave base model. In the implementation coding of the Transfer-Layer transaction receive function (functions write_address and write_data), the object ‘trans’ of the Transaction-Layer is created from the address and the data (for example, trans_address=address; trans_size=size; in the function write_address; and trans_data=data in the function write_data). Then, the Transaction-Layer transaction receive function ‘write(trans)’ is called. This applies also to the Transaction-Layer transaction receive function ‘read’. The Transaction-Layer transaction receive functions ‘write’ and ‘read’ are declared as a pure virtual function.

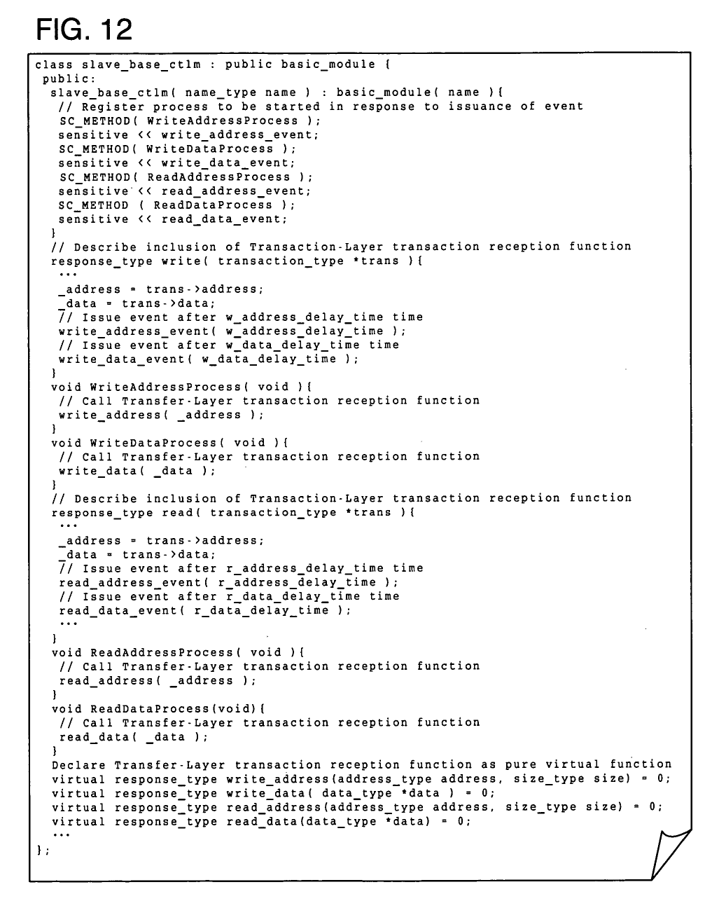

FIG. 12 is a diagram showing an example of the Transfer-Layer slave base model coded in SystemC as one embodiment of the present invention. The process SC_METHOD, which is invoked in response to the issuance of an event, is registered. For example, SC_METHOD(WriteAddressProcess) is invoked in response to write_address_event(write address event). In the implementation of the Transaction-Layer transaction receive function, the address and the data are obtained from the argument *trans and the obtained address and the data are set (_address=trans->address; _data=trans->data). Then, write_address_event is issued after the delay time w_address_delay_time, and write_data_event is issued after the delay time w_data_delay_time. WriteAddressProcess and WriteDataProcess call write_address(_address) and write_data(_data) of the Transfer-Layer respectively. This applies also to the Transaction-Layer transaction receive function ‘read’. The Transfer-Layer transaction receive functions write_address, write_data, read_address, and read_data are declared as a pure virtual function.

Returning to FIG. 8, the bus slave model, which inherits the bus slave base class, is created in step S15.

FIG. 13 is a diagram showing an example of the Transaction-Layer slave model coded in SystemC, in which the Transaction-Layer transaction receive function is implemented. The Transaction-Layer transaction receive function ‘write’ obtains the information from the transfer object (_address=trans->address; _data=tans->data; _size=trans->size).

The Transaction-Layer transaction receive function ‘read’ obtains the information from the transfer object (_address=trans->address; _data=tans->data; _size=trans->size).

The Transaction-Layer slave model, which has inherited the Transaction-Layer slave base class, can receive a Transaction-Layer transaction and a Transfer-Layer transaction simply by implementing the Transaction-Layer API.

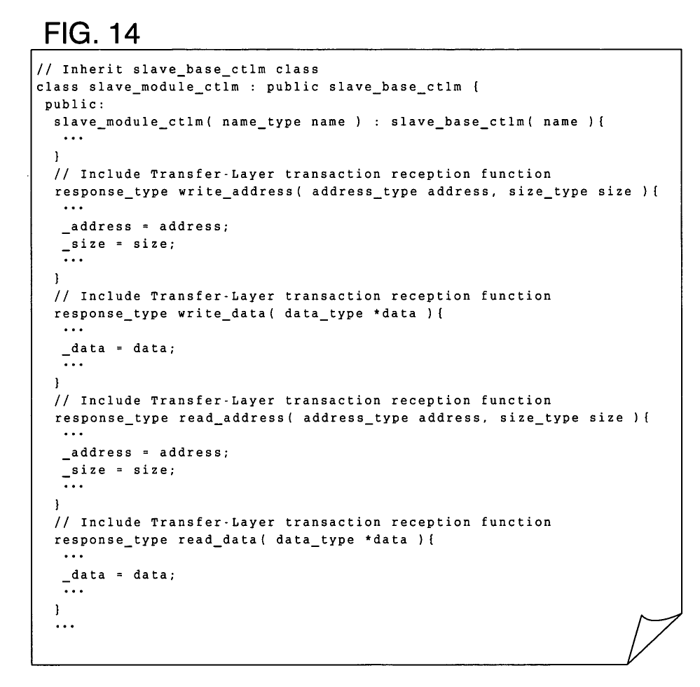

FIG. 14 is a diagram showing an example in which the Transfer-Layer slave model is coded in SystemC. The Transfer-Layer slave model is implemented by including the Transfer-Layer transaction receive functions (write_address, write_data, read_address, read_data). The Transfer-Layer slave model, which inherits the Transfer-Layer slave base class, can receive a Transaction-Layer transaction and a Transfer-Layer transaction simply by implementing the Transfer-Layer API.

While the present invention has been described with reference to the embodiment above, it would be understood that the present invention is not limited to the configuration of the embodiment above and that modifications and changes that may be made by those skilled in the art within the scope of the present invention are included.

It should be noted that other objects, features and aspects of the present invention will become apparent in the entire disclosure and that modifications may be done without departing the gist and scope of the present invention as disclosed herein and claimed as appended herewith.

Also it should be noted that any combination of the disclosed and/or claimed elements, matters and/or items may fall under the modifications aforementioned.

What is claimed is:

1. An apparatus for simulating a bus system including a bus master, a bus slave, and a bus, through which a bus transaction from said bus master is transferred to said bus slave;
said bus slave comprising a bus interface corresponding to one of at least two different abstraction levels of a simulation model, for receiving a bus transaction at said one level; and
a transaction receive unit for receiving a bus transaction corresponding to another level;
said transaction receive unit of said bus slave, responsive to the bus transaction at said another level transferred from said bus master to said bus slave via said bus, accepting the transferred bus transaction at said another level, converting information on the bus transaction at said another level to information corresponding to a bus transaction at said one level, and executing processing corresponding to a bus transaction at said one level.

2. The apparatus according to claim 1, wherein at least two bus masters, which generates at least two types of bus transactions of said different abstraction levels, respectively, are connectable to said bus.

3. The apparatus according to claim 1, wherein, in said bus slave, a base class of said one level has a function for receiving the bus transaction at said another level and executes conversion of the abstraction level in said base class.

4. The apparatus according to claim 3, wherein, in the base class of said one level, a function for receiving the bus transaction at said one level is declared as a pure virtual function, and wherein
when processing corresponding to the bus transaction at said one level is executed in said bus slave, a bus transaction function at said one level, which has inherited the base class, is called.

5. The apparatus according to claim 1, wherein said bus master comprises:
a first bus master that issues a bus transaction at a transfer level to the bus, said transfer level being higher than RTL (Register Transfer Level) in the abstraction level, said transfer level defining an address phase and a data phase of a read and a write as a bus cycle thereof; and
a second bus master that issues a bus transaction at a transaction level to the bus, said transaction level being higher than the transfer level in the abstraction level, said transaction level defining a read and a write as a bus cycle thereof;
said bus transferring a bus transaction issued from said first and second bus masters to a destination bus slave; wherein
a base model of a slave, which has a transfer level bus interface, includes a transaction layer transaction receive function for receiving a transaction level bus transaction; and wherein
in case of a transaction level bus transaction being transferred to said bus slave, said transaction layer transaction receive function receives the transferred transaction level bus transaction, converts transfer information of the transaction level bus transaction to information corresponding to the transfer level bus transaction, and calls a function corresponding to the transfer level transaction, while in case of the transfer level bus transaction being transferred to said base slave, a transfer layer transaction receive function is called.

6. The apparatus according to claim 1, wherein a base model of a slave, which has a transaction level bus interface, includes a transfer layer transaction receive function for receiving a transfer level bus transaction; and wherein
in case of a transfer level bus transaction being transferred to said bus slave, said transfer layer transaction receives function receives the transferred transfer level bus transaction, converts transfer information to transfer information corresponding to the transaction level bus transaction, and calls a function corresponding to the transaction level transaction,
while in case of the transaction level bus transaction being transferred to said base slave, a transaction layer transaction receive function is called.

7. A method for simulating a bus system including a bus master, a bus slave, and a bus, said method comprising the steps of:
issuing, by said bus master, a bus transaction at least at one of at least two different abstraction levels of a simulation model to the bus; and
transferring, by said bus, the bus transaction from said bus master to said bus slave,
wherein in said bus slave having a bus interface corresponding to one of the two different abstraction levels, a transaction receive function for receiving a bus transaction at another level is provided; and wherein
when a bus transaction at said another level is transferred from said bus master to said bus slave via said bus,
said method further comprises the steps of:
said transaction receive function receiving the bus transaction at said another level,
said transaction receive function converting the received bus transaction to a bus transaction at said one level; and
said transaction receive function calling a function corresponding to a bus transaction at said one level.

8. The method according to claim 7, wherein, in said bus slave, a base class of said one level has a function for receiving the bus transaction at said another level and the abstraction level is converted in the base class.

9. The method according to claim 8, wherein, in the base class of said one level, a function for receiving the bus transaction at said one level is declared as a pure virtual function; and
wherein when processing corresponding to the bus transaction at said one level is executed, a bus transaction function at said one level, which inherits the base class, is called.

10. The method according to claim 8, wherein, as the bus master,
a first bus master that issues a bus transaction at a transfer level to the bus, said transfer level being higher than RTL (Register Transfer Level) in the abstraction level, said transfer level defining an address phase and a data phase of a read and a write as a bus cycle thereof; and
a second bus master that issues a bus transaction at a transaction level to the bus, said transaction level being higher than the transfer level in the abstraction level, said transaction level defining a read and a write as a bus cycle thereof,
are connected to said bus;
said bus transferring a bus transaction issued from said first and second bus masters to a destination bus slave; wherein
a base model of the slave, which has a transfer level bus interface, includes a transaction layer transaction receive function for receiving a transaction level bus transaction; and wherein
in case of a transaction level bus transaction being transferred to said bus slave, said transaction layer transaction receive function receives the transferred transaction level bus transaction, converts transfer information to transfer information corresponding to the transfer level bus transaction, and calls a function corresponding to the transfer level transaction, while in case of the transfer level bus transaction being transferred to said base slave, a transfer layer transaction receive function is called.

11. The method according to claim 8, wherein a base model of the slave, which has a transaction level bus interface, includes a transfer layer transaction receive function for receiving a transfer level bus transaction, and wherein
in case of a transfer level bus transaction being transferred to said bus slave, said transfer layer transaction receive function receives the transferred transfer level bus transaction, converts transfer information to transfer information corresponding to the transaction level bus transaction, and calls a function corresponding to the transaction level transaction, while in case of the transaction level bus transaction being transferred to said base slave, a transaction layer transaction receive function is called.

12. A computer program causing a computer constituting an apparatus for simulating a system including a bus, a bus master and a bus slave to perform:
processing in which the bus master issues a bus transaction at least at one of at least two different abstraction levels of a simulation model to the bus; and
processing in which said bus transfers the bus transaction from said bus master to the bus slave,
wherein in the bus slave having a bus interface corresponding to one of the two levels, a transaction receive function for receiving a bus transaction at another level is provided, and wherein
in case of a bus transaction at said another level being transferred from said bus master to said bus slave via said bus, said program further causing the computer to perform processing in which the transaction receive function for receiving the bus transaction at said another level receives the bus transaction at said another level, converts the received bus transaction to a bus transaction at said one level, and calls a function corresponding to a bus transaction at said one level.

13. The program according to claim 12, wherein, in said bus slave, a base class of said one level has a function for receiving the bus transaction at said another level and the abstraction level is converted in the base class.

14. The program according to claim 13, wherein, in the base model of said one level, a function for receiving the bus transaction at said one level is declared as a pure virtual function and, when processing corresponding to the bus transaction at said one level is executed, a bus transaction function at said one level, which inherits the base class, is called.

15. The program according to claim 12, wherein, as the bus master,
a first bus master that issues a bus transaction at a transfer level to the bus, said transfer level being higher than RTL (Register Transfer Level) in the abstraction level, said transfer level defining an address phase and a data phase of a read and a write as a bus cycle thereof; and
a second bus master that issues a bus transaction at a transaction level to the bus, said transaction level being higher than the transfer level in the abstraction level, said transaction level defining a read and a write as a bus cycle thereof,
are provided,
said program causing said computer to perform processing in which
said bus transfers a bus transaction issued from said bus masters to said bus slave,
wherein a base model of the slave, which has a transfer level bus interface, includes a transaction layer transaction receive function for receiving a transaction level bus transaction,
said program further causing said computer to perform processing in which,
in case of a transaction level bus transaction being transferred to said bus slave, said transaction layer transaction receive function receives the transferred transaction level bus transaction, converts transfer information to transfer information corresponding to the transfer level bus transaction, and calls a function corresponding to the transfer level transaction, while in case of the transfer level bus transaction being transferred to said base slave, a transfer layer transaction receive function is called.

16. The program according to claim 12, wherein a base model of the slave, which has a transaction level bus interface, includes a transfer layer transaction receive function for receiving a transfer level bus transaction
said program further causing said computer to perform processing in which,
in case of a transfer level bus transaction being transferred to said bus slave, said transfer layer transaction receive function receives the transferred transfer level bus transaction, converts transfer information to transfer information corresponding to the transaction level bus transaction, and calls a function corresponding to the transaction level transaction, while in case of the transaction level bus transaction being transferred to said base slave, a transaction layer transaction receive function is called.
